(19) United States
(12) Patent Application Publication
(10) Pub. No.: US 2016/0217487 A1
(43) Pub. Date: Jul. 28, 2016

(54) REDEEMING COUPONS USING INSTRUCTIONS STORED AT A REMOTE STORAGE LOCATION

(71) Applicant: Toshiba Global Commerce Solutions Holdings Corporation, Tokyo (JP)

(72) Inventors: Dean Frederick Herring, Youngsville, NC (US); Bilal Aziz, Durham, NC (US); Susan Brosnan, Raleigh, NC (US); David Klages, Morrisville, NC (US)

(21) Appl. No.: 14/603,451

(22) Filed: Jan. 23, 2015

(51) Int. Cl. G06Q 30/02

(52) U.S. Cl. CPC G06Q 30/0238

(57) ABSTRACT

A computing device is communicatively coupled to an optical scanner and redeems coupons by receiving data produced by an optical scan of a product code associated with a coupon. The product code encodes a primary processing action to be performed by the computing device when processing the coupon and a modifier identifying a remote storage location. The remote storage location stores instructions defining a secondary processing action to be performed by the computing device when processing the coupon. The computing device detects a predetermined trigger event associated with processing the coupon, and in response, retrieves the instructions defining the secondary processing action from the remote storage location. The computing device executes the instructions to redeem the coupon according to the secondary processing action.

### TECHNICAL FIELD

The present disclosure relates to a computing device for redeeming coupons using instructions stored at a remote storage location.

### BACKGROUND

Coupons are commonly used to provide consumers with discounts for particular goods and services. In order to efficiently redeem a coupon, the benefits of that coupon are commonly encoded in a product code. A product code is a representation of data that can be read by a computing device using an optical scanner. Typical optical scanners work by employing one or more sensors to sense light reflected off of objects and generate a corresponding signal. This signal can be processed by the computing device associated with the scanner in order to decode the product code. These product codes can be encoded according to a number of different symbologies depending upon their structure. For example, the Universal Product Code (UPC) is a common symbology for encoding a product code that uses a linear barcode structure, and the Quick Response (QR) code is a common symbology for encoding a product code that uses a matrix barcode structure.

Traditional coupons are printed on paper and presented to the computing device for redemption. Digital coupons, however, may be presented on the display of a portable electronic device for redemption by the computing device. Whether traditional or digital, once a coupon has issued it typically cannot be modified. Further, in order for coupons to be redeemable at a wide variety of retail locations, the product codes thereon are typically encoded according to a fixed format. Therefore, coupons can be inflexible, and therefore not suitable for use in certain situations.

### BRIEF DESCRIPTION OF THE DRAWINGS

FIG. 1 illustrates an exemplary network according to embodiments of the present disclosure.

FIG. 2A illustrates an example of a linear barcode according to the prior art.

FIG. 2B illustrates an example of a matrix barcode according to the prior art.

FIG. 3 illustrates a logical representation of redeeming a coupon according to embodiments of the present disclosure.

FIG. 4 illustrates an exemplary method for redeeming a coupon according embodiments of the present disclosure.

FIG. 5 illustrates a further exemplary method for redeeming a coupon according to embodiments of the present disclosure.

FIG. 6 illustrates exemplary hardware useful for implementing the methods described herein, according to one or more embodiments of the present disclosure.

FIG. 7 illustrates a computer program product for redeeming coupons according to embodiments of the present disclosure.

### DETAILED DESCRIPTION

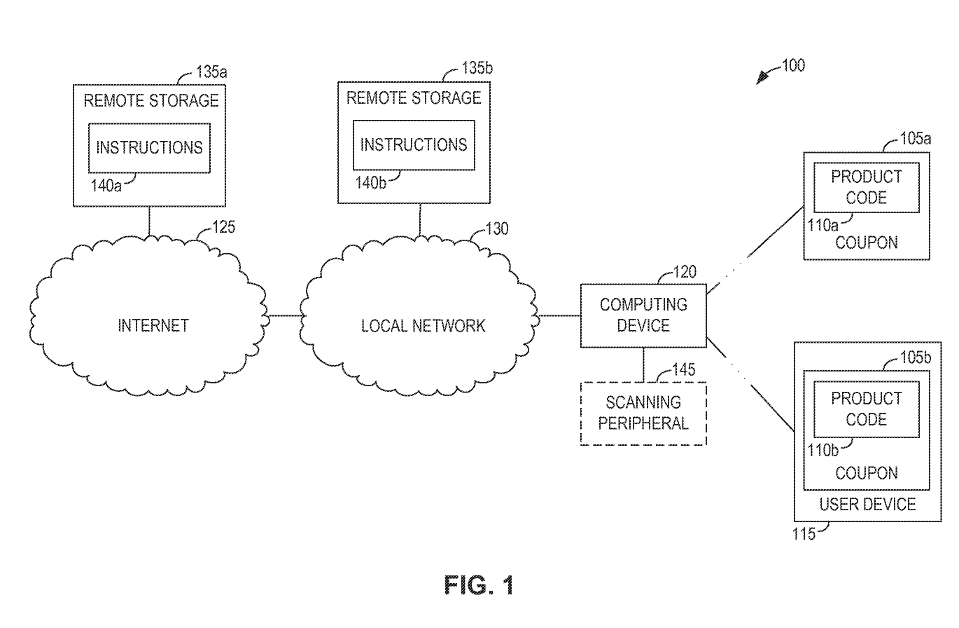

Embodiments of the present disclosure generally relate to redeeming coupons comprising product codes using a computing device. FIG. 1 illustrates an exemplary network 100 according to various embodiments. The network 100 comprises a computing device 120 communicatively connected to a scanning peripheral 145, such as a scanner, for example, and a local network 130. The local network 130, in turn, is communicatively coupled to a public IP network 125, such as the Internet. Both public network 125 and local network 130 are communicatively connected to devices configured for remote storage 135a, 135b.

In operation, the scanning peripheral 145 optically scans product codes 110a, 110b, which may comprise a barcode or Quick Response (QR) code, for example, that is printed on a coupon 105a or displayed as part of an electronic coupon 105b on user device 115. The scanning peripheral 145 communicates the information obtained from the scan to computing device 120. Then, upon receipt, the computing device 120 performs one or more primary and/or secondary actions, as described in more detail below, to redeem coupon 105a, 105b.

According to the embodiments of the present disclosure, remote storage 135a, 135b comprises one or more storage devices configured to store data and information that is accessed by computing device 120. Some examples of remote storage 135a, 135b include, but are not limited to, network attached storage devices, storage area networks, cloud storage, hosted file services, and database servers. Additionally, remote storage 135a, 135b may be configured to perform the same types of functions, essentially differing only with regard to their physical location in network 100, or fulfill dramatically different roles. For example, remote storage 135b attached to local network 130 may comprise one or more computing devices that are dedicated to supporting only a single retail location associated with computing device 120, whereas remote storage 135a may comprise one or more storage devices for regionally supporting multiple retail locations of a retail chain. In another example, remote storage 135a, 135b may comprise one or more computing devices associated with a manufacturer of a particular product. In these cases, remote storage 135a, 135b may support of a variety of different retail outlets or locations at which the manufacturer's products can be purchased.

While the figures illustrate remote storage 135a, 135b as being physically remote from computing device 120, those of ordinary skill in the art should appreciate that remote storage 135a, 135b need not be physically separated from computing device 120 by a geographically vast distance. In some embodiments, computing device and one or both of remote storage 135a, 135b are co-located. Additionally, although two instances of remote storage 135a, 135b are depicted in FIG. 1, one of ordinary skill in the art should recognize that embodiments of the present disclosure may involve any number of instances configured for the storage of data and information.

Computing device 120 includes computing hardware that can be operated by a user in order to process customer transactions involving the redemption of coupon 105a, 105b. An example of such a computing device 120 is a Point-of-Sale (POS) terminal commonly found at retail locations in support of consumer purchases. According to the present disclosure, computing device 120 receives data obtained from optical scans of product codes 110a, 110b from scanning peripheral 145. These product codes 110a, 110b, as described later in more detail, encode information and data that is used by the computing device 120 to redeem the coupon 105a, 105b. By way of example, the data encoded into the product code 110a, 110b may include a processing action to be performed by the computing device when processing the coupon for redemption, a modifier identifying a location at remote storage 135a, 135b that stores instructions 140a, 140b, and a trigger event or condition that, when satisfied, controls the computing device 120 to retrieve the instructions 140a, 140b from the location specified in the modifier.

The scanning peripheral 145 may comprise any type of optical scan circuitry known in the art. In some embodiments, scanning peripheral 145 comprises optical scanning circuitry that is integrated into computing device 120. In other embodiments, however, scanning peripheral 145 comprises a separate optical scanning device communicatively coupled to computing device 120. As previously stated, the scanning peripheral 145 is configured to optically scan the product code 110a, 110b of coupon 105a, 105b to obtain the data encoded therein, and then pass that data to the computing device 120. Upon receipt, computing device 120 may perform the primary processing action and/or a secondary processing action when processing the coupon, as described in more detail below.

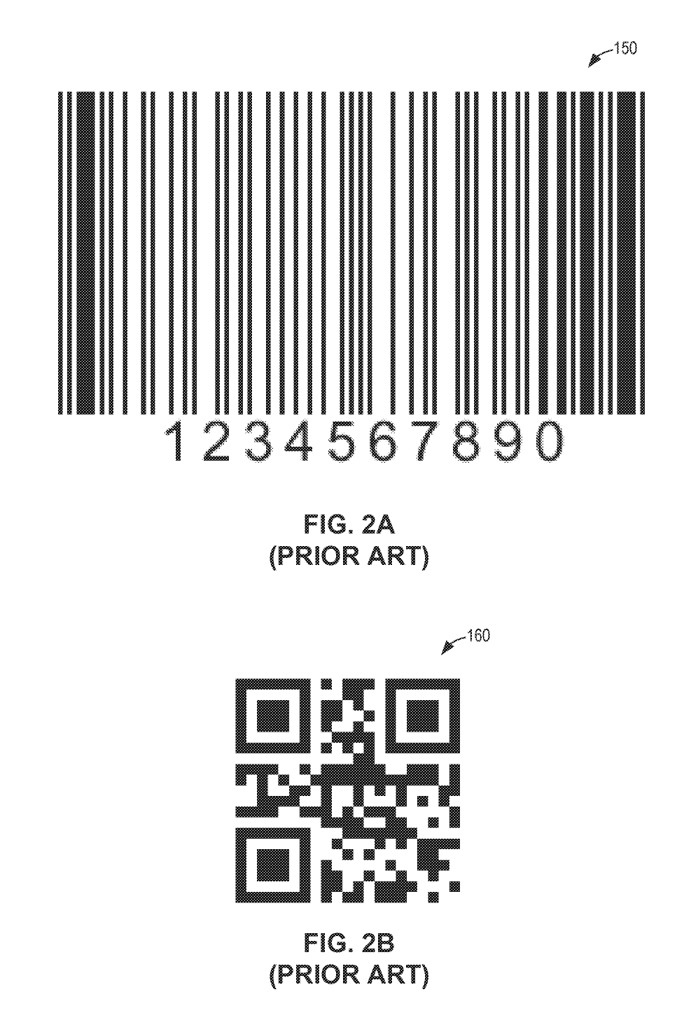

The product codes 110a, 110b may generally be implemented using a variety of different structures. The structure employed by the product code 110a, 110b also influences the symbology that is used to encode information within that structure. When a product code 110a, 110b is structured such that it can be decoded by analyzing it along a single axis (e.g., horizontally), it is typically referred to as a linear, or one-dimensional, barcode. FIG. 2A depicts an example of a linear barcode 150 according to the prior art. Structurally, linear barcode 150 presents a series of vertical bars and spaces that governs how the linear barcode 150 can be read. The symbology employed by linear barcode 150 governs how the vertical bars and spaces are decoded into useful information. For example, linear barcode 150 is encoded according to the Code 93 symbology, which is just one of many well-known symbologies. Other well-known linear barcode 150 symbologies include, but are not limited to, UPC, Codabar, Pharmacode, Code 11, Code 39, and Code 128. The horizontal thickness of the vertical bars and spaces of the linear barcode 150 of FIG. 2A, according to the Code 93 symbology, encodes the series of digits “1234567890.” Although it is common for text corresponding to the information encoded by a linear barcode 150 to be presented along with the linear barcode 150 itself (as depicted in FIG. 2A), such is not required. The corresponding text is typically provided solely for the convenience of human readers, and is not part of the linear barcode symbology. Thus, the human-readable text is typically not used when linear barcode 150 is scanned by a machine.

The linear barcode 150 in FIG. 2A only encodes digits; however, the Code 93 symbology also supports encoding letters and punctuation characters. Indeed, there are numerous symbologies for encoding linear barcodes 150, each of which can support different character sets and symbols. In order to appropriately decode a linear barcode 150, the terminal that scans the linear barcode 150 must be programmed to support the particular symbology the linear barcode 150 employs.

Another type of product code can be decoded by analyzing it along two-axes (e.g., horizontally and vertically). This type of product code is often referred to as a matrix, or two-dimensional, barcode. FIG. 2B depicts an example of a matrix barcode 160, also referred to as a Quick Response (QR) code, according to the prior art. The pattern of black squares on a white background of the matrix barcode 160 of FIG. 2B, according to the QR code symbology, encodes the text-based message “Hello World.” Just as linear barcodes 150 can be encoded using various symbologies, so, too, can matrix barcodes 160.

Those of ordinary skill in the art will readily appreciate that QR code symbology is not the only symbology suitable for encoding matrix barcodes 160. For example, another matrix barcode symbology is Portable Data File 417 (PDF417). The PDF417 symbology is often referred to as being structured as a stacked barcode, because the PDF417 structure stacks a series of linear barcodes on top of each other.

Various traditional barcodes, whether linear or matrix, also support control symbols that improve the ability of machines to recognize and decode the traditional barcode 150 and/or matrix barcode 160. For example, the Code 128 symbology typically starts with an initial quiet zone, followed by a start character. These two control characters enhance a terminal's ability to recognize the beginning of a linear barcode, such as linear barcode 150, encoded according to the Code 128 symbology. In addition, the Code 128 symbology often appends a check character, stop character, and closing quiet zone to the end of linear barcode 150. The check character is a checksum that helps the terminal identify whether it has accurately recognized the data encoded within the linear barcode 150. The stop character and closing quiet zone help the terminal to identify the end of the linear barcode 150.

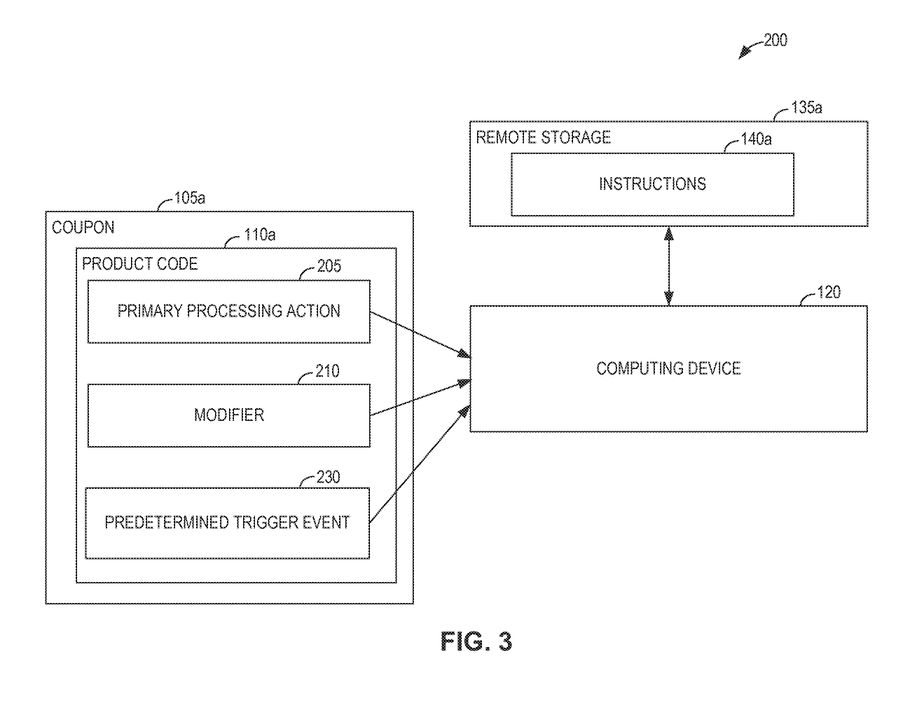

As stated above, embodiments of the present disclosure involve data obtained in an optical scan of a product code that encodes a primary processing action to be performed by the computing device 120 when redeeming the coupon, a modifier that points to a set of instructions that may be used to alter the processing action(s) performed by the computing device 120, and in some embodiments, a trigger event or condition that must be satisfied before the computing device can alter its processing actions according to the set of instructions indicated be the modifier. FIG. 3 depicts a logical representation 200 according for redeeming a coupon that includes such a product code according to one embodiment.

It should be noted, however, that in this embodiment, FIG. 3 particularly illustrates the coupon as comprising a printed coupon 105a having product code 110a printed thereon. However, this is for illustrative purposes only. The coupon 105a seen in FIG. 3 may, in some embodiments, comprise a digital coupon 105b having a digital product code 110b. However, aside from the manner in which the product code 110a, 110b is displayed for scanning, the processing operations performed by computing device 120 are the same.

As seen in FIG. 3, coupon 105a comprises product code 110a in which the primary processing action 205 and modifier 210 are encoded. Additionally, in at least some embodiments of the present disclosure, a predetermined trigger event 230 is encoded in the product code 110a. As described in more detail below, the encoded data comprising the primary processing action 205, the modifier 210, and the predetermined trigger event 230 is utilized to control the computing device 120 of the present disclosure to redeem the coupon 105a in a dynamic manner.

More particularly, the primary processing action 205 comprises encoded data, such as a code or instructions, for example, which identify a particular processing action to be performed by the computing device 120 to redeem the coupon 105a. For example, primary processing action 205 may comprise instructions that control the computing device 120 to apply a specified discount (e.g., 20%) to an item being purchased by a consumer. Under normal circumstances, the computing device 120 may simply process the coupon 105a and discount the product by the specified 20%. In other circumstances, however, the computing device 120 may be controlled to alter its performance of the primary processing action 205 according to the defined set of secondary instructions 140a.

Modifier 210 identifies the location of a remote storage device, such as an address at remote storage 135a, for example, that stores the set of secondary instructions 140a. By way of example only, modifier 210 may comprise a Universal Resource Locator (URL), a domain name, an Internet Protocol (IP) address, or the like, from where the computing device 120 may download instructions 140a. According to the embodiments of the present disclosure, the modifier 210 may be scanned and the information contained therein passed to the computing device 120. However, before computing device 120 will interpret that address information to retrieve the instructions 140a, computing device 120 must determine that a predetermined event has occurred. In this embodiment, the information utilized by computing device 120 to make this determination is encoded in the predetermined trigger event 230.

More specifically, the predetermined trigger event 230 encodes information that identifies an event or condition, for example, which must be satisfied before computing device 120 can alter the primary processing action 205 it performs to redeem the coupon 105a. The predetermined event triggers 230 may be defined by a manufacturer of a product or a retailer associated with selling the product, for example, and may be defined as any type of event or condition needed or desired. However, in accordance with some embodiments of the present disclosure, the predetermined trigger event 230 includes data that identifies one or more of a time-based event (e.g., an expiration date has passed or the coupon is being redeemed within a predefined date or time range), a location-based event (e.g., the coupon is being redeemed within a predetermined geographic region or at a predetermined store), and an event based on information or data associated with a device involved in the redemption of the coupon (e.g., a device is nearby that has an identifier matching one or more predetermined identifiers).

For example, in some embodiments, the predetermined trigger event 230 of product code 110a defines a timing requirement associated with a special promotion of the product, such as to ensure that a date on which the coupon is redeemed (i.e., a current date) is not beyond a predefined expiration date, and/or is within a predetermined date range associated with the special promotion. If the computing device 120 determines that the “trigger” event has occurred (e.g., the current date is beyond the identified expiration date or is within the specified data range), the computing device 120 will retrieve the instructions 140a from the remote storage 135a based on the URL or other address-related information identified in the modifier 210. Once the set of secondary instructions 140a is retrieved, computing device 120 executes those instructions to perform the secondary processing action in addition to, or in lieu of, the primary processing action 205.

By way of example only, when coupon 105a associated with a product is being redeemed, the primary processing action 205 of coupon 105a may control computing device 120 to discount a price of the product by 20%. However, if the coupon is expired and/or the date on which the customer is redeeming the coupon falls within a specified date range, as defined by predetermined trigger event 230, computing device will access remote storage 135a at the address specified by modifier 210 and download the set of secondary instructions 140a from that address. Once downloaded, computing device 120 will perform the secondary processing action as defined by those downloaded instructions.

In some embodiments, such secondary actions may control computing device 120 to perform a modified version of the primary processing action 205. For example, rather than discount the price by 20%, the computing device 120 may discount the price of the associated product by a lesser or greater amount. In other embodiments, the set of secondary instructions 140a controls computing device 120 to replace the instructions of the primary processing action 205 altogether with a complete different set of instructions such that computing device 120 performs a completely different processing action. For example, rather than discount the product by 20%, as initially indicated by the primary processing action, computing device 120 may be controlled according to the set of secondary instructions 140a to discount a completely different product by the same or a different amount. In still other embodiments, the set of secondary instructions 140a controls computing device 120 to perform an action that supplements the primary processing action 205. Thus, in at least one embodiment, computing device 120 may be controlled to redeem the coupon 105a according to both sets of instructions (e.g., discount the product by 20% as initially indicated, and in addition, discount the same or a different product by another percentage or fixed amount). Regardless of the particular embodiment, however, performing a secondary processing action at computing device 120 when processing coupon 105a depends on the particular set of secondary instructions 140a retrieved by the computing device 120.

Those of ordinary skill in the art will appreciate that the timing requirements are not limited to contiguous ranges or fixed dates. In some embodiments, the timing requirement indicated in the predetermined trigger event 230 might stipulate that the secondary processing action be applied by computing device 120 only on a specific day of the week, or only after, or during, a specific time. One of ordinary skill will recognize the various additional ways in which such a timing requirement can be specified by the data obtained from the optical scan, and how the computing device 120 would check the current date and/or time to detect whether that timing requirement has been satisfied.

In addition to such time-based trigger events, computing device 120 may be controlled to process coupon 105a based on a specific location requirement that has been satisfied. For example, the predetermined trigger event 230 may identify a predefined region or retail location. If, when processing the scanned data, computing device 120 determines that a device associated with the transaction is in the predetermined region or retail location, computing device 120 would retrieve the set of secondary instructions 140a from the address defined in modifier 210. Upon retrieving the instructions 140a, computing device may perform a secondary processing action defined by the set of secondary instructions 140a to replace, modify, or supplement the primary processing action 205.

The data obtained from the optical scan of the product code 110a need not specify a geographic location, or range of locations, within which a device associated with the redemption of coupon 105a must occur. In some embodiments, for example, the geographic locations identified by the predetermined trigger event 230 specify an exclusion zone within which retrieving the instructions 140a is appropriate. Further, the location requirement is not limited solely to geographic regions. By way of example only, a location requirement might stipulate that the computing device 120 be within a particular retail outlet in order to implement a promotion that is exclusive to a particular retailer.

Other requirements for the predetermined trigger event are also possible. One of ordinary skill will recognize various additional ways in which a location requirement can be specified by the data obtained from the optical scan, and how the computing device 120 would check the current location of the computing device 120 in order to detect whether that location requirement has been satisfied.

Additionally, other trigger events are contemplated by the present disclosure for controlling the processing of a coupon by computing device 120. For example, in embodiments where the coupon being redeemed is a digital coupon 105b, the predetermined trigger event 230 may indicate that the computing device 120 should be communicatively connected to the user device 115 of the consumer displaying the coupon 105b (e.g., paired via a BLUETOOTH link, Near-Field Communication (NFC), or Wi-Fi Direct link). Alternatively, or additionally, the predetermined trigger event 230 may identify specific identifiers or other parameters that are stored in memory of the computing device 120 and/or the user device 115. In these cases, computing device 120 could communicate with the user device 115 to obtain certain information, or retrieve it from its own memory, for example, and determine if the obtained information matches the information identified in the predetermined trigger event 230. If so, the computing device 120 would retrieve the set of secondary instructions 140a, 140b as indicated by the address information of modifier 210, and execute the retrieved instructions to perform the secondary processing action, as previously described.

As an example, the customer associated with the user device 115 may be a member of a customer loyalty program. Identifiers associated with such membership may be stored in the memory of one or both of the user device 115 and the computing device 120. Upon receiving the scan data, computing device 120 identifies, based on the predetermined trigger event 230, a particular identifier, or a range of identifiers, for which computing device 120 should apply a secondary processing action.

To determine whether performing the secondary processing action is appropriate for user device 115, computing device 120 may first ensure that the communications link is established with the user device 115 that is displaying product code 110b, and not some other device in the environment, such as the devices of other customers. By way of example only, computing device may request, and receive, a device identifier from the user device 115, such as a serial number or Media Access Control (MAC) address. Computing device 120 may then detect that the device identifier received via the established communications link matches one of the preconfigured device identifiers stored in its own memory, and thus, belongs to the user device 115 being scanned.

Having detected that the device identifier received from user device 115 matches a preconfigured device identifier, computing device 120 is triggered to retrieve a set of secondary instructions 140b from remote storage devices 135b, for example, and executes those instructions upon receipt to implement a benefit associated with the customer loyalty program. For example, the instructions 140a may define a secondary processing action that controls the computing device 120 to modify the primary processing action 205 by doubling a 20% discount initially indicated by the primary processing action 205, and then apply the modified discount. Thus, according to embodiments of the present disclosure, computing device 120 can be selectively and dynamically controlled according to a set of secondary processing actions, when redeeming coupon 105a, to ignore, modify, or supplement the actions that are initially associated with the coupon 105a with a different discount or benefit to the customer without having to reprint or reissue the coupon 105a.

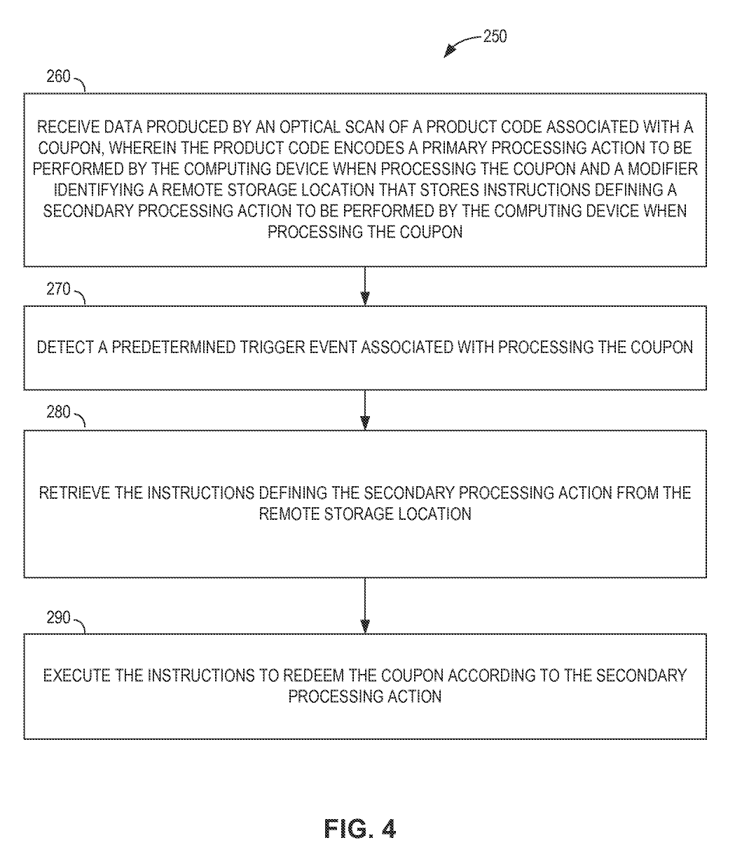

FIG. 4 illustrates one possible method 250 for a computing device 120 to redeem a coupon 105a, 105b. Computing device 120 receives data produced by an optical scan of a product code, such as product code 110a, for example, associated with coupon 105a (block 260). The product code 110a encodes a primary processing action 205 to be performed by the computing device 120 when processing the coupon 105a, a modifier 210 identifying the location of a set of secondary instructions 140a on remote storage 135a, and in some embodiments, a predetermined trigger event 230 that determines whether computing device 120 will retrieve the secondary instructions 140a and perform a secondary processing action in accordance with those instructions. Upon detecting the predetermined trigger event 230 associated with processing the coupon 105a (block 270), as described above, computing device 120 retrieves the instructions 140a defining the secondary processing action from the remote storage 135a (block 280), and then performs a secondary processing action by executing the instructions 140a to redeem the coupon 105a (block 290), as previously described.

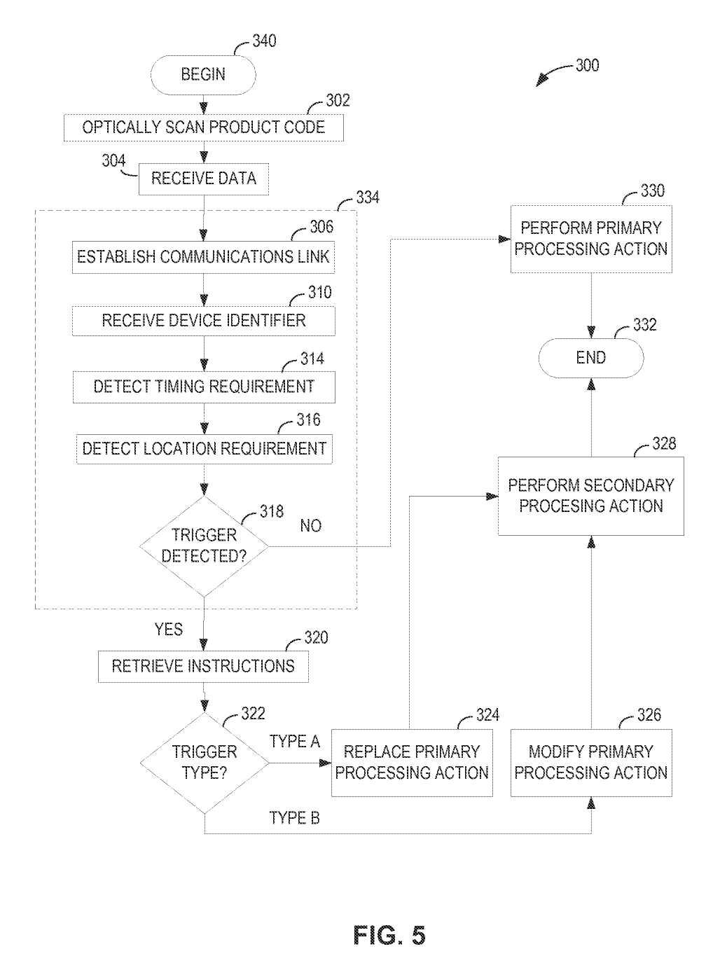

FIG. 5 illustrates a more detailed method 300 for redeeming a coupon, such as coupon 105b. To begin the method 300 (block 340), computing device 120 optically scans a product code, such as product code 110b associated with coupon 105b, displayed on user device 115 (block 302). The product code 110b encodes a primary processing action 205 to be performed by the computing device 120 when processing the coupon 105b, and a modifier 210, identifying a remote storage location 135a that stores instructions 140a. The instructions 140a, as stated above, define a secondary processing action to be performed by the computing device 120 when processing the coupon 105b. The optical scan produces data, which is received by the computing device 120 (block 304).

Having received the data, computing device 120 may detect a predetermined trigger event 230 associated with processing the coupon 105b (region 334). For example, detecting the predetermined trigger event 230 may comprise one or more of detecting that a timing requirement that has been satisfied, detecting that a location requirement that has been satisfied, and detecting that a user device 115 with which the computing device 120 is paired comprises certain information. Of course, these requirements are for purposes of illustration only. Other embodiments of the present disclosure may configure additional, fewer, or different requirements for detection of the predetermined trigger event 230 as needed or desired. In addition, computing device 120 may also be able to detect one or more of several predetermined triggers based on a variety of different individual requirements, or combinations thereof. For example, satisfaction of a timing requirement and a location requirement may result in detecting a predetermined trigger event 230 of Type A, whereas detecting a user device with which the computing device is paired may result in detecting a predetermined trigger event 230 of Type B.

In method 300, detection of the predetermined trigger event 230 comprises establishing a communications link with the user device 115 (block 306) and receiving a device identifier from the user device 115 over the established communications link (block 310). Detecting the predetermined trigger event 230 also comprises detecting a timing requirement (block 314) and a location requirement (block 316) specified in the data produced from the optical scan. If the timing requirement is not satisfied, the location requirement is not satisfied, and the device identifier does not match any of a plurality of preconfigured device identifiers stored in memory (e.g., because the computing device 120 and the user device 115 are not paired), the predetermined trigger event 230 is not detected (block 318). Accordingly, the computing device 120 processes the coupon 105b by performing the primary processing action 205 encoded by the product code 110b (block 330) and the method 300 ends (block 332).

If, however, the timing requirement is satisfied, the location requirement is satisfied, or the device identifier matches any of a plurality of preconfigured device identifiers stored in memory, the computing device 120 will detect a predetermined trigger event (block 318). In response, computing device 120 retrieves the instructions 140a defining the secondary processing action from the location at remote storage 135a as identified by modifier 210 (block 320).

Having retrieved the instructions 140a from the remote storage location 135a, the computing device 120 executes the instructions 140a in order to redeem the coupon 105b according to the secondary processing action, which varies depending upon the type of predetermined trigger event 230 the computing device 120 detected (block 322). According to embodiments, the instructions 140a comprise a policy specifying one or more rules to be followed for the various predetermined trigger event 230 types. For example, if a predetermined trigger event 230 of Type A is detected, executing the instructions 140a to redeem the coupon 105b comprises replacing the primary processing action 205 (block 324). However, if a predetermined trigger event 230 of Type B is detected, executing the instructions 140a to redeem the coupon 105b comprises modifying the primary processing action 205 (block 326). In either case, the computing device 120 will perform the secondary processing action (i.e., using the replacement or modification of the primary processing action as appropriate) in order to redeem the coupon 105b (block 328).

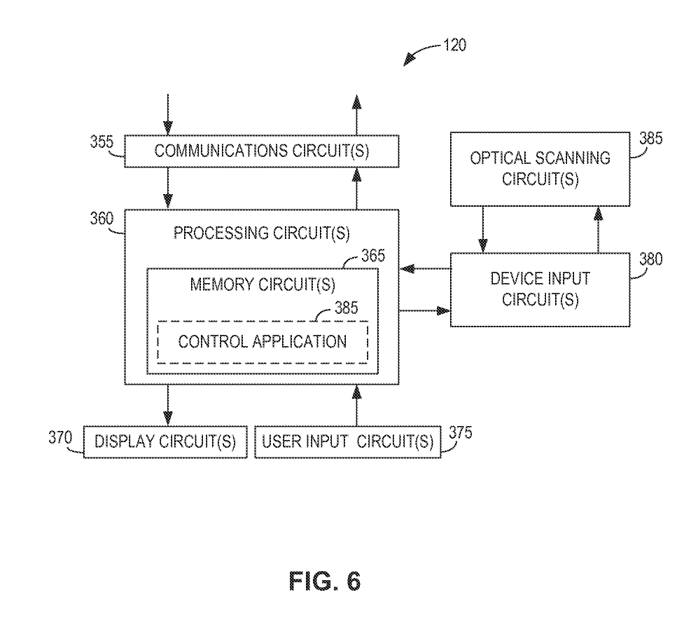

FIG. 6 illustrates an exemplary computing device 120 that may be used to implement the coupon redeeming procedures described herein according to one or more embodiments. In this embodiment, computing device 120 comprises one or more processing circuits 360 including a memory circuit 365. As seen in FIG. 6, the memory circuit 385 and the processing circuit(s) 360 comprise a unitary circuit. However, the computing device 120 of the present disclosure is not so limited. In other embodiments, the memory circuit 385 and the processing circuit(s) 360 are separate, but communicatively connected circuits.

The computing device 120 further comprises one or more communications circuits 355, one or more display circuits 370, one or more user input circuits 375, one or more device input circuits 380, and in some embodiments, one or more optical scanning circuits 385. Each of these circuits, as seen in FIG. 6, are communicatively connected to the processing circuit(s) 360 via a bus, for example.

The communications circuit(s) 355 are configured to exchange messages with other devices, such as remote storage 135a, 135b and user device 115, over a communications network such as networks 125 and/or 130 or via a direct peer-to-peer connection. For example, the communications circuit(s) 355 may comprise analog and/or digital transceiving circuitry capable of communicating with each other, or with other devices, according to one or more communication protocols known in the art or that may be developed, such as HTTP, RTP, RTCP, HTTPs, Ethernet, TCP/IP, ATM, or the like. The communications circuit(s) 355 implement receiver and transmitter functionality appropriate to the communication network to which it is attached (e.g., optical, electrical, and the like). The transmitter and receiver functionality may share circuit components and/or software, or alternatively may be implemented separately within the one or more communications circuits 355.

The display circuit(s) 370 are configured to present visual output to a user. For example, the display circuit(s) 370 may be comprised within one or more of a graphics adapter, a graphical processing unit, a display port, a Liquid Crystal display, and a Light Emitting Diode display. The user input circuit(s) 375 are configured to accept input from a user. For example, the user input circuit(s) 375 may be comprised within one or more of a pointing device (such as a mouse, stylus, touchpad, trackball, pointing stick, joystick), a touchscreen, a microphone for speech input, an optical sensor for optical recognition of gestures, and a keyboard.

The optical scanning circuit(s) 385 are configured to perform a scan of a product code 105a, 105b, as previously described, and provide that scanned data to the computing device 120 via the device input circuit(s) 380. For example, the device input circuit(s) 380 may comprise a physical port, such as a universal serial port, parallel port, optical port, and the like, for interfacing with peripheral devices comprising the optical scanning circuit(s) 385. The device input circuit(s) 380 may also comprise a wireless interface such as BLUETOOTH. According to embodiments, the device input circuit(s) 380 are configured to receive data produced by an optical scan of a product code 110 associated with a coupon 105, wherein the product code 110 encodes a primary processing action 205 to be performed by the computing device 120 when processing the coupon 105, and a modifier 210 identifying a remote storage 135 location that stores instructions 140 defining a secondary processing action to be performed by the computing device 120 when processing the coupon 105.

Processing circuit(s) 360 may comprise one or more microprocessors or similar hardware, as is known in the art. For example, the processing circuit(s) 360 may comprise any sequential state machine capable of executing machine instructions stored as machine-readable computer programs in the memory circuit(s) 365, such as one or more hardware-implemented state machines (e.g., in discrete logic, FPGA, ASIC, etc.); programmable logic together with appropriate firmware; one or more stored-program, general-purpose processors, such as a microprocessor or Digital Signal Processor (DSP), together with appropriate software; or any combination of the above. As stated above, the processing circuit(s) 360 are configured to detect a predetermined trigger event 230 associated with redeeming the coupon 105a, 105b. In response to detecting the predetermined trigger event 230, the processing circuit(s) 360 are further configured to retrieve the address location identified in the modifier 210, and then retrieve the instructions 140a, 140b defining the secondary processing action from that address location, such as from remote storage 135a, 135b. Once retrieved, processor circuit(s) 360 execute the instructions 140a, 140b to redeem the coupon 105a, 105b according to the secondary processing action.

As seen in FIG. 6, the memory circuit(s) 365 and the processing circuit(s) 360 are illustrated as a unitary component. However, those of ordinary skill in the art should appreciate that the computing device 120 of the present disclosure is not limited to this particular structure. In some embodiments, the processing circuit(s) 360 and the memory circuit(s) 365 may comprise separate, but communicatively connected, circuits.

In addition, memory circuit(s) 365 may comprise a non-transitory storage medium configured to store a control application 385 for controlling the functions of computing device 120. The memory circuit(s) 365 may comprise any non-transitory machine-readable media known in the art or that may be developed, including but not limited to magnetic media (e.g., floppy disc, hard disc drive, etc.), optical media (e.g., CD-ROM, DVD-ROM, etc.), solid state media (e.g., SRAM, DRAM, DDRAM, ROM, PROM, EPROM, Flash memory, solid state disc, etc.), or the like. The control application 385 is a computer program comprising instructions that, when executed by processing circuit(s) 360, configure computing device 120 to perform the embodiments of the present disclosure as previously described.

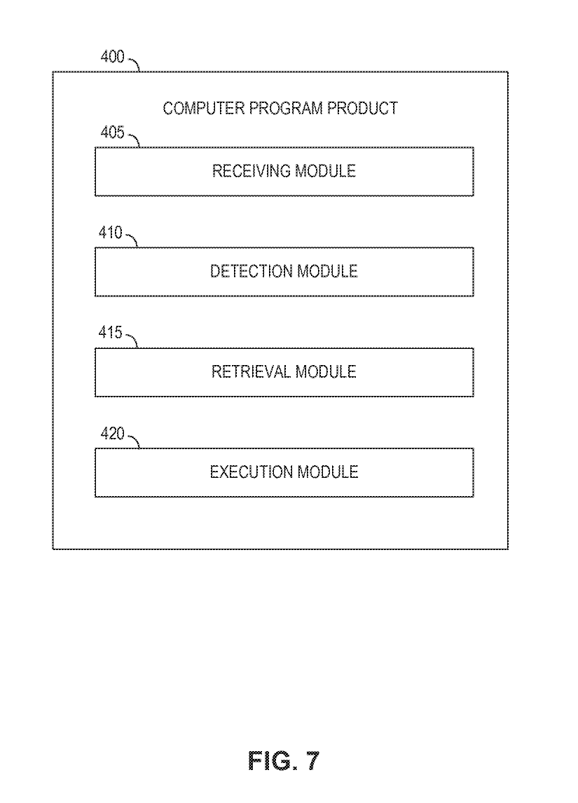

Another aspect of the disclosure, as illustrated in FIG. 7, comprises a computer program product 400 that may, for example, be embodied in a non-transitory, computer-readable medium, such as the memory circuit(s) 365 of computing device 120. Computer program product 400 may also be embodied in, for example, a removable memory device, e.g., a thumb drive or disc. The computer program product 400 may also operate as control application 385 either in whole or in part. The computer program product 400 comprises at least one of a receiving module 405, a detection module 410, a retrieval module 415, and an execution module 420. The receiving module 405 comprises program code that when executed by the processing circuit(s) 360 causes the device input circuit(s) 380 to receive data produced by an optical scan of a product code 110a, 110b associated with a coupon 105, wherein the product code 110 encodes a primary processing action 205 to be performed by the computing device 120 when processing the coupon 105a, 105b, and a modifier 210 identifying a remote storage 135a, 135b location that stores instructions 140a, 140b defining a secondary processing action to be performed by the computing device 120 when processing the coupon 105a, 105b.

The detection module 410 comprises program code that when executed by the processing circuit(s) 360 causes the processing circuit(s) 360 to detect a predetermined trigger event 230 associated with redeeming the coupon 105a, 105b. The retrieval module 415 comprises program code that when executed by the processing circuit(s) 360 causes the processing circuit(s) 360 to, in response to detecting the predetermined trigger event 230, retrieve the address location identified in the modifier 210, and then retrieve the instructions 140a, 140b defining the secondary processing action from that address location, such as from remote storage 135a, 135b. The execution module 420 comprises program code that when executed by the processing circuit(s) 360 causes the processing circuit(s) 360 to execute the instructions 140a, 140b to redeem the coupon 105a, 105b according to the secondary processing action.

Those skilled in the art will appreciate the various types of optically-recognizable structures and symbologies that would be suitable for implementing the product codes described herein. Those skilled in the art will also appreciate that the various methods and processes described herein may be implemented using various hardware configurations that generally, but not necessarily, include the use of one or more microprocessors, microcontrollers, digital signal processors, or the like, coupled to memory storing software instructions or data for carrying out the techniques described herein. In particular, those skilled in the art will appreciate that the circuits of various embodiments may be configured in ways that vary in certain details from the broad descriptions given above.

For instance, one or more of the processing functionalities discussed above may be implemented using dedicated hardware, rather than a microprocessor configured with program instructions. Such variations, and the engineering tradeoffs associated with each, will be readily appreciated by the skilled practitioner. In addition, the optical scanning functionalities may be integrated with the computing device hardware itself, or may be provided by a peripheral device in communication with the computing device. Since the design and cost tradeoffs for the various hardware approaches, which may depend on system-level requirements that are outside the scope of the present disclosure, are well known to those of ordinary skill in the art, further details of specific hardware implementations are not provided herein.

The previous embodiments describe the predetermined event trigger 230 as being encoded in the product code 110a, 110b. However, those of ordinary skill in the art will appreciate that such encoding is not required. Rather, the predetermined trigger event 230 may comprise information at computing device 120, or at some other location accessible to computing device 120. Thus, the embodiments of the present disclosure may be carried out in other ways than those specifically set forth herein without departing from the essential characteristics of the disclosure. The present embodiments are to be considered in all respects as illustrative and not restrictive, and all changes coming within the meaning and equivalency range of the appended claims are intended to be embraced therein.

What is claimed is:

1. A method for redeeming coupons, the method performed at a computing device communicatively coupled to an optical scanner and comprising:
receiving data produced by an optical scan of a product code associated with a coupon, wherein the product code encodes:
a primary processing action to be performed by the computing device when processing the coupon; and
a modifier identifying a remote storage location that stores instructions defining a secondary processing action to be performed by the computing device when processing the coupon;
detecting a predetermined trigger event associated with processing the coupon; and
responsive to detecting the predetermined trigger event:
retrieving the instructions defining the secondary processing action from the remote storage location; and
executing the instructions to redeem the coupon according to the secondary processing action.

2. The method of claim 1, further comprising redeeming the coupon according to the primary processing action in addition to executing the instructions to redeem the coupon according to the secondary processing action.

3. The method of claim 1:
wherein the instructions retrieved from the remote storage location comprise a predetermined rule; and
wherein executing the instructions to redeem the coupon according to the secondary processing action comprises:
modifying the primary processing action according to the predetermined rule; and
redeeming the coupon according to the modified primary processing action.

4. The method of claim 1, wherein detecting the predetermined trigger event comprises at least one of:
detecting that the data produced by the optical scan specifies a timing requirement that has been satisfied;
detecting that the data produced by the optical scan specifies a location requirement that has been satisfied.

5. The method of claim 4, wherein detecting that the data produced by the optical scan specifies the satisfied location requirement comprises:
determining one or more geographic regions from the data produced by the optical scan; and
determining that the computing device is currently located within at least one of the one or more geographic regions.

6. The method of claim 1:
wherein one or more preconfigured device identifiers are stored in a memory of the computing device;
wherein detecting the predetermined trigger event comprises:
establishing a communications link with a user device;
receiving a device identifier from the user device via the established communications link; and
detecting that the received device identifier matches any of the preconfigured device identifiers stored in the memory.

7. The method of claim 1, wherein the data produced by the optical scan of the product code is produced by optically scanning the product code from a display of a user device.

8. The method of claim 1, wherein executing the instructions to redeem the coupon according to the secondary processing action comprises ignoring the primary processing action.

9. The method of claim 1:
wherein detecting the predetermined trigger event associated with processing the coupon comprises determining a trigger event type; and
wherein executing the instructions to redeem the coupon according to the secondary processing action comprises executing instructions that correspond to the determined trigger event type.

10. A computing device comprising:
a device input circuit configured to receive data produced by an optical scan of a product code associated with a coupon, wherein the product code encodes:
a primary processing action to be performed by the computing device when processing the coupon; and
a modifier identifying a remote storage location that stores instructions defining a secondary processing action to be performed by the computing device when processing the coupon; and
a processing circuit communicatively coupled to the device input circuit and configured to:
detect a predetermined trigger event associated with processing the coupon; and
responsive to detecting the predetermined trigger event:
retrieve the instructions defining the secondary processing action from the remote storage location; and
execute the instructions to redeem the coupon according to the secondary processing action.

11. The computing device of claim 10, wherein the processing circuit is further configured to redeem the coupon according to the primary processing action in addition to executing the instructions to redeem the coupon according to the secondary processing action.

12. The computing device of claim 10:
wherein the instructions retrieved from the remote storage location comprise a predetermined rule; and
wherein to execute the instructions to redeem the coupon according to the secondary processing action, the processing circuit is further configured to:
modify the primary processing action according to the predetermined rule; and
redeem the coupon according to the modified primary processing action.

13. The computing device of claim 10, wherein to detect the predetermined trigger event, the processing circuit is further configured to detect at least one of:
that the data produced by the optical scan specifies a timing requirement that has been satisfied;
that the data produced by the optical scan specifies a location requirement that has been satisfied.

14. The computing device of claim 13, wherein to detect that the data obtained from the optical scan specifies the satisfied location requirement, the processing circuit is further configured to:
determine one or more geographic regions from the data produced by the optical scan; and
determine that the computing device is currently located within at least one of the one or more geographic regions.

15. The computing device of claim 10, further comprising:
a communications circuit communicatively coupled to the processing circuit and configured to:
establish a communications link with a user device;
receive a device identifier from the user device via the established communications link;
wherein the processing circuit comprises a memory configured to store one or more preconfigured device identifiers; and
wherein to detect the predetermined trigger event, the processing circuit is further configured to detect that the received device identifier matches any of the one or more preconfigured device identifiers stored in the memory.

16. The computing device of claim 10, further comprising an optical scanning circuit communicatively coupled to the device input circuit, wherein the optical scanning circuit is configured to:
produce the data in response to optically scanning the product code;
send the data to the device input circuit.

17. The computing device of claim 16, wherein to optically scan the product code, the optical scanning circuit is further configured to optically scan the product code from a display of a user device.

18. The computing device of claim 10, wherein to execute the instructions to redeem the coupon according to the secondary processing action, the processing circuit is further configured to ignore the primary processing action.

19. The computing device of claim 10:
wherein to detect the predetermined trigger event associated with processing the coupon, the processing circuit is further configured to determine a trigger event type; and
wherein to execute the instructions to redeem the coupon according to the secondary processing action, the processing circuit is further configured to execute instructions that correspond to the determined trigger event type.

20. A computer program product stored in a non-transitory computer readable medium for controlling a programmable computing device communicatively coupled to an optical scanner, the computer program product comprising software instructions that, when run on the programmable computing device, cause the programmable computing device to:
receive data produced by an optical scan of a product code associated with a coupon, wherein the product code encodes:
a primary processing action to be performed by the computing device when processing the coupon; and
a modifier identifying a remote storage location that stores further instructions defining a secondary processing action to be performed by the computing device when processing the coupon;
detect a predetermined trigger event associated with processing the coupon; and
responsive to detecting the predetermined trigger event:
retrieve the further instructions defining the secondary processing action from the remote storage location; and
execute the further instructions to redeem the coupon according to the secondary processing action.
